(19) United States
(12) Patent Application Publication
(10) Pub. No.: US 2010/0174413 A1
(43) Pub. Date: Jul. 8, 2010

(54) Environmental Apparatus Control System

(76) Inventors: Hidenori Fujino, Sakai-shi (JP); Yoshifumi Murakami, Ibaraki-shi (JP)

Correspondence Address: Cheng Law Group, PLLC, 1100 17th Street, N.W., Suite 503, Washington, DC, 20036, US

(21) Appl. No.: 11/884,380

(22) PCT Filed: Jan. 18, 2006
(86) PCT No.: PCT/JP2006/301086

§ 371 Date: Aug. 15, 2007

(30) Foreign Application Priority Data
Feb. 23, 2005 (JP) 2005-048037

(51) Int. Cl. G06F 1/32; G05D 23/19; G06F 1/28; G06N 5/02

(52) U.S. Cl. 700/277; 700/291; 706/47

(57) ABSTRACT

An environmental apparatus control system provides and transmits a message voluntarily to each resident as to the current control being made to residential space or environment in which the residents are presence. The system includes an apparatus for controlling the residential environment and a plurality of personal terminals belonging to individual residents in the residential environment. Each terminal is utilized to enter one of opposed demands with regard to the residential environment. The system analyzes which one of the opposed demands is predominant and determines a control project of controlling the apparatus in a direction of satisfying the predominant demand. An information provider is included in the system to provide a message indicating the number of each one of the opposed demands, and transmit the message to the personal terminals voluntarily. Thus, each resident can be regularly informed of the control project or how the control is made in consideration of the demands from the individual residents without making any particular requesting action.

### TECHNICAL FIELD

The present invention is related to an environmental apparatus control system, and more particularly to a control system for controlling an air-conditioning apparatus of a residential environment in accordance with demands from residents.

### BACKGROUND ART

Japanese Patent Publication No. 2004-205202 discloses an environmental apparatus control system which is configured to collect demands from residents and compose a control project which controls an air-conditioning apparatus to change or keep the temperature of a residential space in accordance with predominant demands. The system is given a capability of providing a message regarding the control project as well as the collected and transmitting the message to the residents upon request by the resident. Since the message is transmitted only upon request by the resident, each resident has to make a positive action in order to get information as to whether or not the current control project reflects his or her demand. Thus, the system gives increased burden on the side of the residents, and is therefore insufficient for the residents to get persuasive information effortlessly as to the current control being made for the residential space.

### DISCLOSURE OF THE INVENTION

In view of the above insufficiency and problem, the present invention has been achieved to provide an environmental apparatus control system which is capable of providing and transmitting a message voluntarily to each resident as to the current control being made to residential space or environment. The control system in accordance with the present invention includes an apparatus configured to control the residential environment, and a plurality of personal terminals belonging to individual residents in the residential environment. Each personal terminal is configured to input demands of changing the residential environment. The demand includes a first demand and a second demand which are opposed to each other. The system also includes a demand collector configured to collect the demands from the personal terminals, and a project creator configured to give an analysis of the collected demands to determine which one of the first and second demands is predominant, and to determine a control project of controlling the apparatus in a direction of satisfying the one of the first and second demands determined to be predominant at regular intervals. An apparatus controller is provided to control the apparatus in accordance with the control project. Further included in the system is an information provider which is configured to provide a message indicating the number of the first demand and the second demand, and transmit the message to the personal terminals voluntarily at a timing determined by the system. Accordingly, each of the residents can be regularly informed of the control scheme or how the control is made in consideration of the demands from the individual residents without making any particular requesting action.

Preferably, the demand collector is configured to collect the total number of the residents so that the information provider gives the message indicating a proportion of the first demand and the second demand in the total number of the residents. The proportion can well represent the predominance of the demands for easy confirmation and understanding of the current control by the resident.

The information provider is preferred to provide and transmit the message each time the project creator determines the control project.

The demand collector may be configured to have resident information data indicating which personal terminal sends which one of the first and second demands. In this connection, the information provided is configured to provide a persuasive message to the personal terminal of the residents whose demand is not adopted in the control project. The persuasive message is prepared to notify why the demand is not adopted. Thus, the resident can be easy to understand why the current control is not adopted and be well persuaded of the situation.

Further, the information provider may be configured to provide a notice that the system is not capable of accepting the demand until the controlled environment condition is settled. The notice is transmitted to the personal terminals of the residents together with the persuasive message. Thus, the user can be free from inputting the ineffective demands until the environment condition, for example, the temperature is settled in match with the control project. Thus, the notice can give well information when the demands can be effectively considered or not considered at the system, improving the system utility.

Preferably, the information collecting mean is configured to judge whether the demand from each of the individual personal terminals comply with a rule of saving energy with reference to a criteria. In this connection, the information provider is configured to provide a confirm message to the personal terminal sending the demand which is judged not to comply with said rule, prompting the resident to reconsider the demand. Thus, the system can induce the resident to reconsider the demand in view of the energy-saving.

These and still other advantageous features of the present invention will become more apparent from the following detailed description of the embodiment when taken in conjunction with the attached drawings.

### BRIEF DESCRIPTION OF THE DRAWINGS

FIG. 1 is a schematic view illustrating an environmental apparatus control system in accordance with the present invention;

FIG. 2 is a block diagram of the above system;

FIG. 3 is a view illustrating an input window form created on the display of a personal terminal utilized in the above system;

FIGS. 4A and 4B are views respectively illustrating the input window forms of the personal terminal;

FIG. 5 is a flowchart illustrating the operation of the above system;

FIG. 6 is a view illustrating an output window form created on the display of the personal terminal; and

FIG. 7 is a flowchart illustrating another operation of the above system.

### BEST MODE FOR CARRYING OUT THE INVENTION

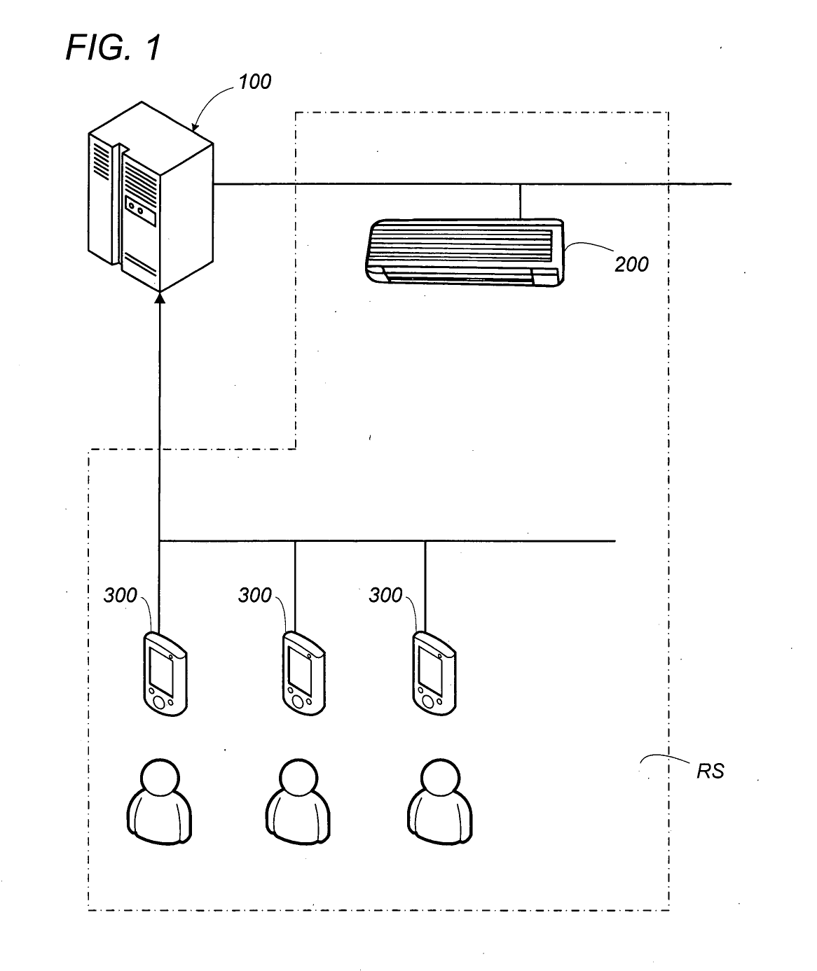

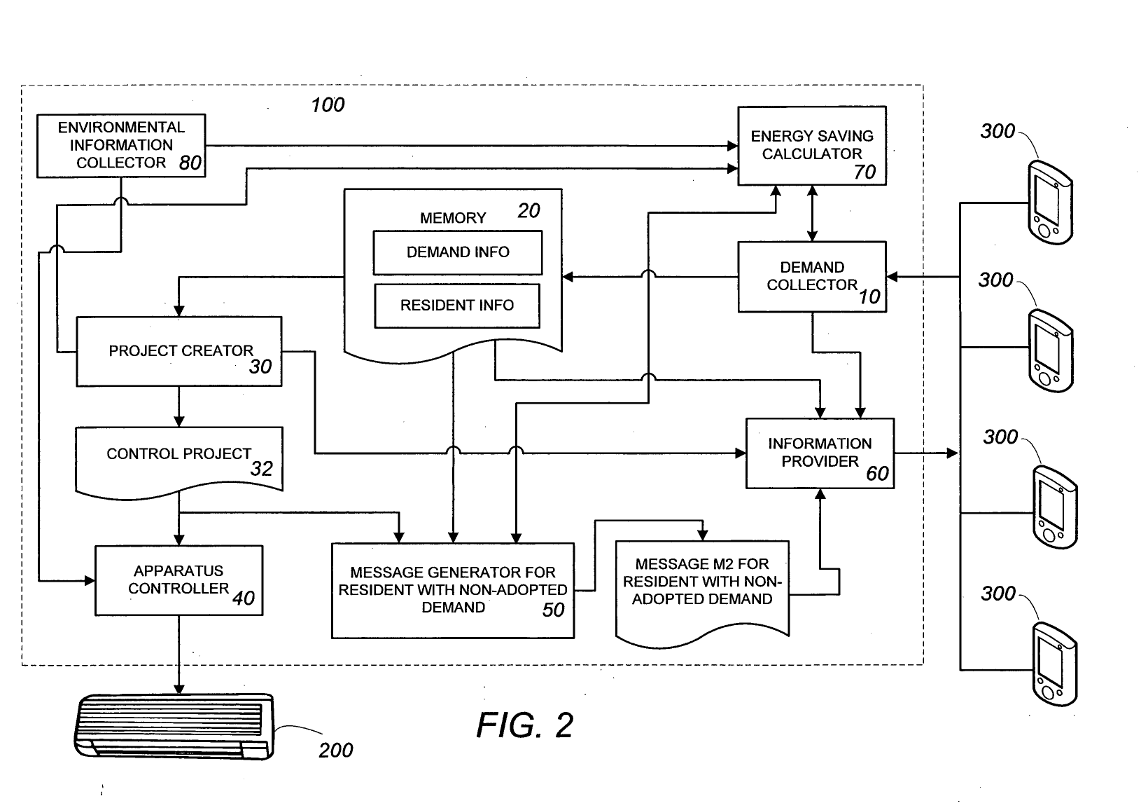

Referring now to FIGS. 1 and 2, there is shown an environmental apparatus control system in accordance with a preferred embodiment of the present invention. In the present embodiment, the system is specifically configured to control air-conditioning apparatus 200 for managing a temperature of an enclosed residential space (RS) in a building in consideration of demands from residents in the space, although the present invention is not limited thereto. The system includes a server 100 connected through a network to a plurality of personal terminals 300 such as personal data assisting device (PDA) respectively belonging to residents in the residential space (RS).

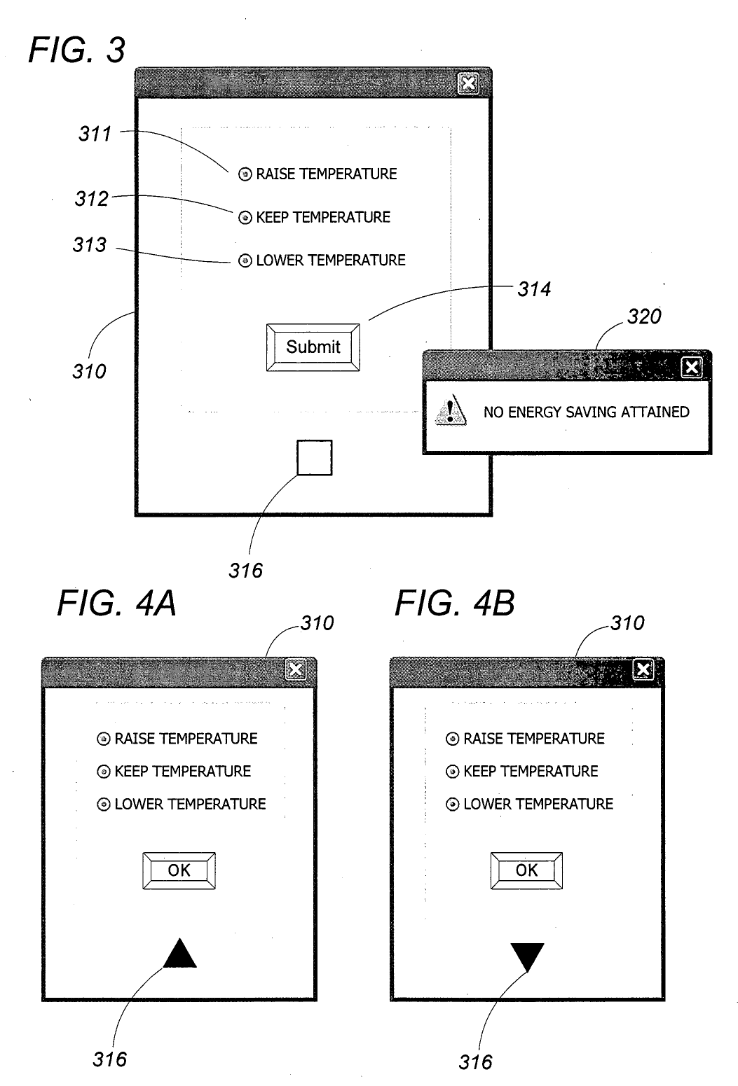

As shown in FIG. 2, the server 100 is configured to provide functional units which are combined to determine a control project for controlling the air-conditioning apparatus 200 in consideration of the demands of the residents collected through the personal terminals 300. The units basically include a demand collector 10, a memory 20, a project creator 30, an apparatus controller 40, message generator 50, and an information provider 60. The demand controller 10 is configured to collect at regular intervals, for example, 5 minutes an identification code or a specific address assigned to each of the terminals 300 and a resident's demand submitted at each terminal 300. For this purpose, each terminal 300 is programmed to generate on its display an input window form 310 as shown in FIG. 3, prompting the resident to submit the demand, i.e., “raise temperature”, “keep temperature”, or “lower temperature” by selecting one of radio buttons 311, 312, and 313, and pressing a button 314. The input window form 310 also includes a rectangular mark 316 which turns to an upwardly oriented triangle and a downwardly oriented triangle respectively in response to the submission of the demand of “raise temperature” and “lower temperature”, as shown in FIGS. 4A and 4B, for easy confirmation of the demand by the resident. Otherwise, the rectangular mark 316 remains as it is.

The demand is submitted together with the address of the terminal to the demand collector 10 and is then stored in the memory 20 to give time series data of the demands as related to the address of the associated terminal. The address can be utilized to identify the residential space and the associated air-conditioning apparatus 200. The project creator 30 is configured to fetch the most recent demand from each terminal to calculate the numbers of the residents respectively requesting to raise the temperature, to lower the temperature, and to keep the temperature, and obtain the total number of the residents or terminals. Then, the control project creator 30 analyzes these numbers and determine the control project 32 at regular intervals of 30 minutes for example, based upon a predominant rule, i.e. which one of the demands of “raising temperature”, “lowering temperature” and “keeping temperature” is predominant. Thus determined control project 32 is sent to the apparatus controller 40 which responds to generate control parameters while referring to information about operating conditions and characteristics for the air-conditioning apparatus 200 as well as the ambient temperature collected at an environmental information collector 80, and transmit the control parameters to the apparatus 200 for making the intended control in match with the control project 32.

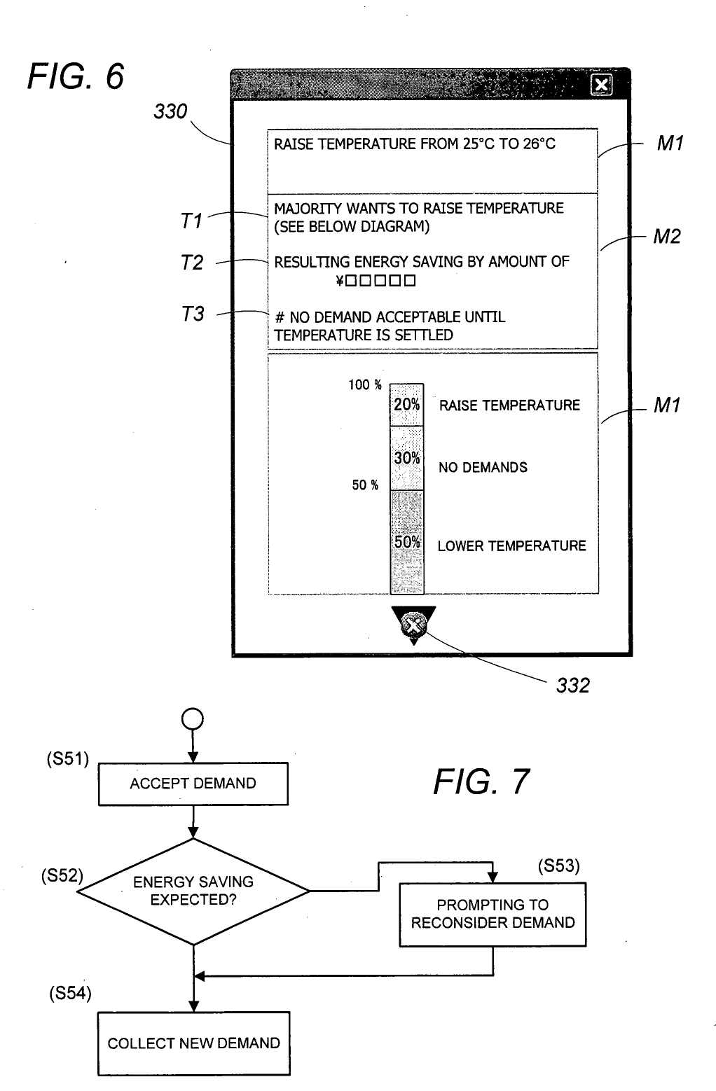

Each time the control project is determined and sent to the apparatus controller 40, the information provider 60 is responsive to create a message M1 indicative of the control project currently determined and send the message to each of the terminals 30, activating it to open an output window form 330 as shown in FIG. 6. The message M1 is composed of a text indicating the control project as well as a graph indicating proportions of the numbers of the demands of “raise temperature”, “lower temperature”, and “keep temperature” with respect to the total number of the residents currently present in the residential space. Note that the number of the demand of “keep temperature” is added to the number of submitting no demand and is labeled in the form 330 as “No Demand”. The total number of the residents is acknowledged at the demand collector 10 to be the number of the terminals being activated, on the promise that the resident presence in the residential space turns on his or her terminal. For this purpose, the information provider 60 gets the currently determined control project from the control project creator 30, a current temperature from a temperature sensor (not shown), and the addresses of the terminal currently activated from the memory 20.

Further, the information provider 60 is responsible for providing a persuasive message M2 selectively transmitted to the terminals of the residents whose demand is not adopted in the control project, explaining the reason why the demand is not adopted. A message generator 50 is provided to create the message M2 for the resident with no-adopted demand. The message generator 50 is configured to get the control project 32 and the addresses of the terminals 300 submitting the non-adopted demand, and an energy saving index in terms of cost calculated at an energy saving calculator 70 to create the message M2 including a text T1 notifying the reason. If the non-adopted demand is judged at the generator 50 to be contrary to the energy saving and therefore the control project is judged to be in conformity with the energy saving, the generator 50 calls the energy saving calculator 70 which responds to calculate the energy saving index with reference to the information as to the operating conditions of the air-conditioning apparatus given from the environmental information collector 80, and sends the energy saving index to the generator 50. The resulting energy saving index is included in a text T2 explaining the effect of the energy saving. Further, the message generator 50 has an additional function of comparing the temperature of the residential space and a target temperature designated by the control project, and creating a notice T3 that the system is not capable of accepting the demands until the target temperature is reached. As shown in FIG. 6, the notice T3 is included in the persuasive message M2 transmitted to the terminals 300 of the residents with non-adopted demand. The notice T3 may be also included in the message M1 transmitted to the terminals of all the residents present in the environmental space.

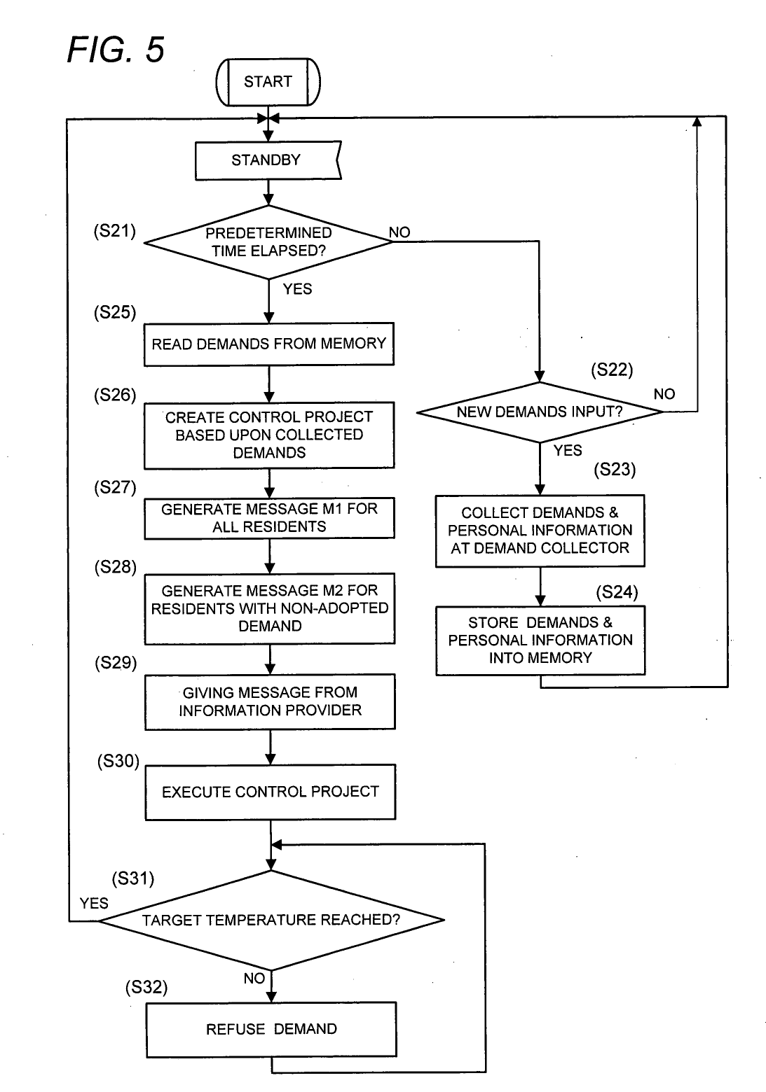

The above operation executed at the server 100 is explained with reference to a flowchart of FIG. 5. The server 200 is kept running so that the demand collector 10 collects the inputs from each of the terminals 300 at regular intervals, for example, 30 minutes. While 30 minutes are not elapsed (S21), the demand collector 10 checks whether the demands are available from the terminals 100 (S22). If available, the demand collector 10 collects and stores the demands in the memory 20 to give time series data of the demands (S23, S24). If not available, or no input is acknowledged, the demand collector 10 is held standby. Upon elapse of 30 minutes, the project creator 30 reads out the time-series data from the memory 20 and fetches recent one for each kind of the demands (S25). Next, the project creator 30 analyzes the demands and creates the control project in accordance with the predominant rule (S26). Then, the information provider 60 creates the message M1 for the all residents present in the environmental space (S27). Subsequently, the message generator 50 selects the terminals which submit the demand not adopted in the control project and creates the persuasive message M2 which is added to the message M1 to be transmitted to the selected terminals 300 (S28). Then, the information provider 60 transmits the message M1 to the terminals of the all residents present in the environmental space and transmits the message M2 together with the message M1 to the selected terminals 300 of the residents with non-adopted demand (S29). Concurrently, the apparatus controller 40 is activated to generate and transmit the control parameters to the air-conditioning apparatus 200 in order to raise, lower, or keep the temperature in accordance with the control project (S30). The target temperature intended by the control project is constantly compared with the actual temperature of the environmental space to check whether the target temperature is reached (S31). Until the target temperature is reached, the demand collector 10 is deactivated to refuse demands from the terminals 300 (S32), while the information provider 60 transmits a disable signal to all of the currently active terminals 300 for displaying an disable marking 332 at the bottom of the output window form 330 of FIG. 6, notifying the resident of that the system is not accept the demands. When the target temperature is reached, the sequence goes back to step (S21), and the information provider 60 transmits a reset signal to each of the terminals for permitting the submission of the demand with the use of the input window format 310, and for clearing the disable marking 332 from the output window form 330.

Further, the demand collector 10 is configured to give an additional information window form 320 in association with the input window form 310 of FIG. 3 on the side of the terminal, when the demand submitted from the terminal is in contrary to the energy saving. As shown in a flowchart of FIG. 7, each time the demand collector 10 acknowledges the submission of the demand from the terminal 300, it calls for the energy saving calculator 70 to evaluate whether the demand is in conformity with or contrary to the energy saving (S52). When the demand is contrary to the energy saving, the demand collector 10 causes the information provider 60 to transmit a feedback signal to the terminal submitting such demand. The feedback signal takes the form of a confirmation message which appears in a pop-up window form 320, as shown in FIG. 2, prompting the resident to reconsider the demand (S53). When the resident submits the demand opposite to the previous demand, the demand collector 10 collects the new demand and cancel the previous demand for determination of the control project.

Although the present invention is explained in the above for one specific embodiment of controlling the air-conditioning apparatus, it should be noted that the environmental apparatus control system of the present invention can be equally applied to illumination control or sound-control system for the enclosed environmental space.

1. An environmental apparatus control system comprising:
an apparatus configured to control a residential environment;
a plurality of personal terminals belonging to individual residents in said residential environment, said personal terminals being each configured to input demands of changing said residential environment, said demand including a first demand and a second demand which are opposed to each other;
a demand collector configured to collect said demands from said personal terminals;
a project creator configured to give an analysis of said collected demands to determine which one of said first and second demands is predominant, and to determine a control project of controlling said apparatus in a direction of satisfying the one of said first and second demands determined to be predominant at regular intervals; and
an apparatus controller configured to control said apparatus in accordance with said control project;
wherein said system includes an information provider which is configured to provide a message indicating the number of the first demand and the second demand, and transmit said message to the personal terminals voluntarily at a timing determined by the system, and
wherein said demand collector is configured to judge whether the demand from each of the individual personal terminals comply with a rule of saving energy with reference to a criteria, and
wherein said information provider is configured to provide a confirm message to the personal terminal sending the demand which is judged not to comply with said rule, prompting the resident to reconsider the demand.

2. The system as set fort in claim 1, wherein
said demand collector is configured to collect the total number of the residents, and
said information provider is configured to provide said message indicating a proportion of said first demand and said second demand in said total number of the residents.

3. The system as set forth in claim 1, wherein said information provider is configured to provide said message each time said project creator creates said control project.

4. The system as set forth in claim 3, wherein
said demand collector is configured to have resident information data indicating which personal terminal sends which one of the first and second demands, and
said information provider is configured to provide a persuasive message to the personal terminal of the residents whose demand is not adopted in said control project, said persuasive message notifying why the demand is not adopted.

5. The system as set forth in claim 4, wherein said information provider is configured to provide a notice that the system is not capable of accepting the demands until the controlled environmental condition is settled, said notice being provided to the personal terminals of the residents together with said persuasive message.

6. The system as set forth in claim 1, wherein
said information collecting mean is configured to judge whether the demand from each of the individual personal terminals comply with a rule of saving energy with reference to a criteria, and
said information provider is configured to provide a confirm message to the personal terminal sending the demand which is judged not to comply with said rule, prompting the resident to reconsider the demand.
